(19) United States
(12) Patent Application Publication
(10) Pub. No.: US 2015/0161175 A1
(43) Pub. Date: Jun. 11, 2015

(54) ALTERNATIVE IMAGE QUERIES

(71) Applicants: Yangli Hector Yee, Campbell, CA (US); Gaurav Garg, Palo Alto, CA (US); Sarah Moussa, Los Altos, CA (US); Charles Rosenberg, Cupertino, CA (US); Radhika Malpani, Palo Alto, CA (US)

(72) Inventors: Yangli Hector Yee, Campbell, CA (US); Gaurav Garg, Palo Alto, CA (US); Sarah Moussa, Los Altos, CA (US); Charles Rosenberg, Cupertino, CA (US); Radhika Malpani, Palo Alto, CA (US)

(73) Assignee: Google Inc.

(21) Appl. No.: 12/028,673

(22) Filed: Feb. 8, 2008

(51) Int. Cl. G06F 17/30

(52) U.S. Cl. CPC G06F 17/30277; G06F 17/30395

(57) ABSTRACT

Methods and systems for suggesting alternative image queries for individual image query search results. In one aspect, a method includes displaying a group of one or more image search results for a first image query, each image search result referring to a respective resource and including a link to the respective resource, receiving first input from a user interacting with a first image search result in the group of one or more image search results, and, in response to receiving the first input, displaying one or more suggested second image queries, where each suggested second image query is associated with the first image search result.

### BACKGROUND

This specification relates to providing alternative image queries.

Internet search engines aim to identify resources (e.g., web pages, images, text documents, processes, multimedia content) that are relevant to a user's needs and to present information about the resources in a manner that is most useful to the user. In response to a query submitted by a user, search engines return search results referring to resources identified as relevant to or matching the query. Unfortunately, a user submitted query may include terms that do not align well with the intentions of the user, for example, if there is ambiguity in the meaning of the query terms. Even if the search results returned are relevant objectively to the user submitted query, the results may not be relevant to or may be broader or narrower than the user's subjective needs. If a user is dissatisfied with the search results returned for a query, the user can attempt to refine the original query to better match the user's needs.

### SUMMARY

This specification describes technologies relating to suggesting alternative image queries for individual image query search results.

In general, one aspect of the subject matter described in this specification can be embodied in methods that include the actions of displaying a group of one or more image search results for a first image query, each image search result referring to a respective resource and including a link to the respective resource, receiving first input from a user interacting with a first image search result in the group of one or more image search results, and, in response to receiving the first input, displaying one or more suggested second image queries, where each suggested second image query is associated with the first image search result. Embodiments of the aspect can include systems, apparatuses, and computer program products.

Implementations of the aspect can optionally include one or more of the following features. Each suggested second image query can be identified based on selection by one or more individuals of the first image search result returned for previous searches of the respective suggested second image query. Each suggested second image query can be selectable to invoke a search of the respective suggested second image query. Second input can be received from the user selecting one of the suggested second image queries, and, in response to receiving the second input, a group of one or more image search results can be displayed for the selected second image query.

In general, in one aspect, a method is provided. The method includes receiving a first image query from a client device, receiving a group of one or more image search results for the first image query, each image search result referring to a respective resource and including a link to the respective resource, for each image search result in the group of one or more image search results, identifying one or more suggested second image queries associated with the respective image search result, and transmitting the group of one or more image search results and the suggested second image queries to the client device for presentation to a user. Embodiments of the aspect can include systems, apparatuses, and computer program products.

Implementations of the aspect can optionally include one or more of the following features. Each image search result in the group of one or more image search results can be identified based on selection by one or more individuals of the respective image search result returned for a previous search of the first image query. Identifying one or more suggested second image queries associated with the respective image search result can include identifying one or more suggested second image queries based on selection by one or more individuals of the respective image search result returned for previous searches of the associated suggested second image queries. Input can be received from the client device indicating that the user selected one of the suggested second image queries, the selected second image query can be provided to a search engine, a group of one or more image search results can be received for the selected second image query, and the group of one or more image search results for the selected second image query can be transmitted to the client device for presentation to the user.

In general, in one aspect, a method is provided. The method includes, for each image search result in a group of one or more image search results for a first image query, identifying a group of one or more second image queries associated with the respective image search result, for each second image query in the group of one or more second image queries associated with the respective image search result, determining a number of selections of the respective image search result associated with the respective second image query, and determining a selection fraction for the respective image search result associated with the respective second image query, and storing in a repository a reference to the respective image search result, the group of one or more second image queries, the numbers of selections, and the selection fractions. Embodiments of the aspect can include systems, apparatuses, and computer program products.

Implementations of the aspect can optionally include one or more of the following features. Determining the number of selections of the respective image search result associated with the respective second image query can include determining a number of instances within a time period the respective image search result was selected by users when the respective image search result was returned for previous searches of the respective second image query. Determining the selection fraction for the respective image search result associated with the respective second image query can include computing a ratio of the number of instances within the time period the respective image search result was selected by users to a number of instances within the time period any image search result was selected by users for previous searches of the respective second image query.

A second image query can be removed from the group of one or more second image queries if the number of selections of the respective image search result associated with the respective second image query is less than a specified value. A second image query can be removed from the group of one or more second image queries if the selection fraction for the respective image search result associated with the respective second image query is less than a specified value. A second image query can be removed from the group of one or more second image queries if the respective second image query includes one or more words from a specified group of words. A second image query can be removed from the group of one or more second image queries if the respective second image query is similar to another second image query in the group.

At least one of the second image queries in the group of one or more second image queries can be used as a label for the respective image search result. At least one of the second image queries in the group of one or more second image queries can be used as a translation for the first image query. At least one of the second image queries in the group of one or more second image queries can be used as an alternative image query for a different image search result that is similar to the respective image search result. Whether the respective image search result is of a genre in a specified group of genres can be determined. The respective image search result can be removed from the group of one or more image search results if the respective image search result is determined to be of a genre in the specified group of genres. Determining whether the respective image search result is of a genre in the specified group of genres can include one or more of comparing a total number of selections of the respective image search result with a specified value, comparing a number of second image queries in the group of one or more second image queries with a specified value, determining a distribution of the numbers of selections of the respective image search result, or determining a semantic similarity of the second image queries in the group of one or more second image queries.

In general, in one aspect, a method is provided. The method includes receiving a first image, identifying one or more second images in a repository of images using one or more byte hashes or simhashes, the one or more identified second images being visually similar to the first image, and providing for the first image one or more labels of the one or more identified second images. Embodiments of the aspect can include systems, apparatuses, and computer program products.

In general, in one aspect, a system is provided. The system includes a client device, and one or more computers operable to interact with the client device and to receive a first image query from the client device, receive a group of one or more image search results for the first image query, each image search result referring to a respective resource and including a link to the respective resource, for each image search result in the group of one or more image search results, identify one or more suggested second image queries associated with the respective image search result, and transmit the group of one or more image search results and the suggested second image queries to the client device for presentation to a user. Embodiments of the aspect can include methods, apparatuses, and computer program products.

Implementations of the aspect can optionally include one or more of the following features. The one or more computers can include a server operable to interact with the client device through a data communication network, and the client device can be operable to interact with the server as a client. The client device can include a personal computer running a web browser or a mobile telephone running a wireless application protocol (WAP) browser.

In general, in one aspect, a system is provided. The system includes a client device, and one or more computers operable to interact with the client device and to, for each image search result in a group of one or more image search results for a first image query, identify a group of one or more second image queries associated with the respective image search result, for each second image query in the group of one or more second image queries associated with the respective image search result, determine a number of selections of the respective image search result associated with the respective second image query, and determine a selection fraction for the respective image search result associated with the respective second image query, and store in a repository a reference to the respective image search result, the group of one or more second image queries, the numbers of selections, and the selection fractions. Embodiments of the aspect can include methods, apparatuses, and computer program products.

Implementations of the aspect can optionally include one or more of the following features. The one or more computers can include a server operable to interact with the client device through a data communication network, and the client device can be operable to interact with the server as a client. The client device can include a personal computer running a web browser or a mobile telephone running a WAP browser.

Particular embodiments of the subject matter described in this specification can be implemented to realize one or more of the following advantages. Query suggestion can be customized for individual search results. Suggested alternative queries allow users to navigate through search results without the need to input new queries. Certain categories of search results (e.g., pornography or caricature) can be detected by analyzing suggested alternative queries identified from user selection patterns. The suggested queries can also serve as automatic labels for search results. These labels can be transferred to other similar search results. Suggested alternative queries can be especially useful for users submitting queries in non-Roman based languages, i.e., a language that is not normally written in a Roman-based alphabet (e.g., Chinese, Japanese, Korean, and Russian), because entering a query in a non-Roman based language can take longer than entering the same query in a Roman-based language.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example search system.

FIG. 2A illustrates an example web page of image search results including suggested alternative queries for one of the image search results.

FIG. 2B illustrates an example web page of image search results returned for the suggested alternative query selected from FIG. 2A.

FIG. 3 shows an example process for displaying suggested second image queries.

FIG. 4 illustrates an example node graph of image search result nodes and query links.

FIG. 5 shows an example process for providing suggested second image queries.

FIG. 6 shows an example process for identifying second image queries for an image search result.

FIG. 7A illustrates example tables of image search results for individual image queries.

FIG. 7B illustrates example tables of image queries for individual image search results.

Like reference numbers and designations in the various drawings indicate like elements.

### DETAILED DESCRIPTION

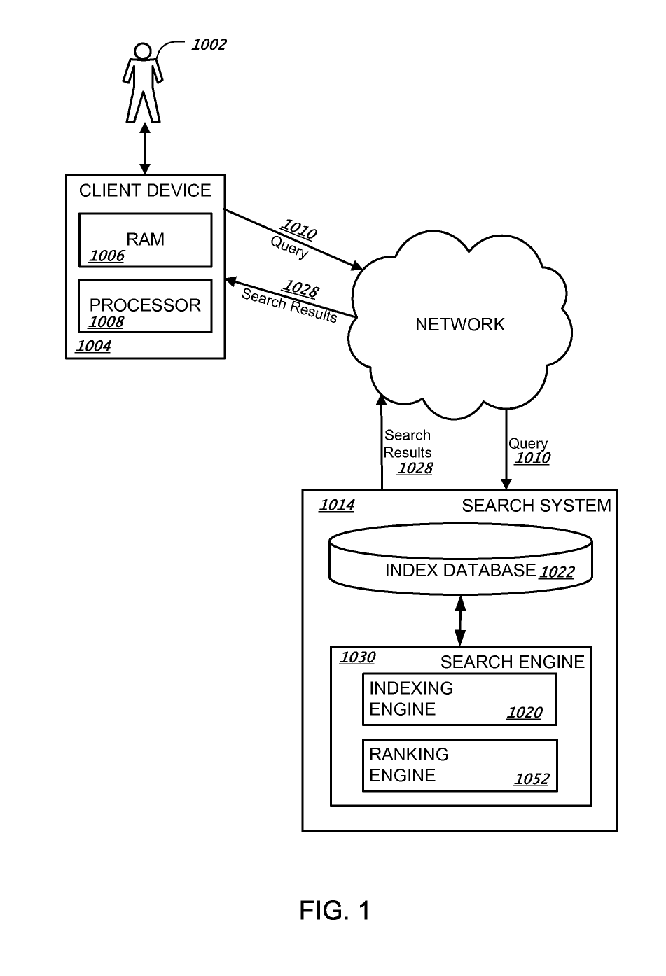

FIG. 1 shows an example search system 1014 for providing search results relevant to submitted search queries as can be implemented in an internet, an intranet, or another client and server environment. The search system 1014 is an example of an information retrieval system in which the systems, components, and techniques described below can be implemented.

A user 1002 can interact with the search system 1014 through a client device 1004 (e.g., a personal computer, a mobile telephone, a personal digital assistant, a mobile audio or video player, a game console, or a combination of one or more of them). For example, the client 1004 can be a computer coupled to the search system 1014 through a local area network (LAN), e.g., an enterprise intranet, or a wide area network (WAN), e.g., the Internet. In some implementations, the search system 1014 and the client device 1004 can be one machine. For example, a user can install a desktop search application on the client device 1004. The client device 1004 will generally include a random access memory (RAM) 1006 and a processor 1008.

A user 1002 can connect to a search engine 1030 within a search system 1014 to submit a query 1010. When the user 1002 submits a query 1010, the query 1010 is transmitted through one or more wired or wireless networks to the search system 1014. The search system 1014 can be implemented as, for example, computer programs running on one or more computers in one or more locations that are coupled to each other through a network. The search system 1014 includes an index database 1022 and a search engine 1030. The search system 1014 responds to the query 1010 by generating search results 1028, which are transmitted through the network to the client device 1004 in a form that can be presented to the user 1002 (e.g., as a search results web page to be displayed in a web browser running on the client device 1004).

When the query 1010 is received by the search engine 1030, the search engine 1030 identifies relevant resources (i.e., resources matching or satisfying the query 1010). The search engine 1030 will generally include an indexing engine 1020 that actively searches a corpus of resources (e.g., web pages, images, or news articles on an intranet or the Internet) to index the resources found in that corpus, and stores index information for the resources in an index database 1022. This index database 1022 is used to identify resources that match the query 1010.

The search engine 1030 will generally include a ranking engine 1052 (or other software) to rank the resources related to the user query 1010. The ranking of the resources can be performed using conventional techniques for determining an information retrieval score for indexed resources in view of a given query. The relevance of a particular resource with respect to a particular query term or to other provided information may be determined by any appropriate technique. The search engine 1030 can transmit the search results 1028 through the network to the client device 1004 for presentation to the user 1002.

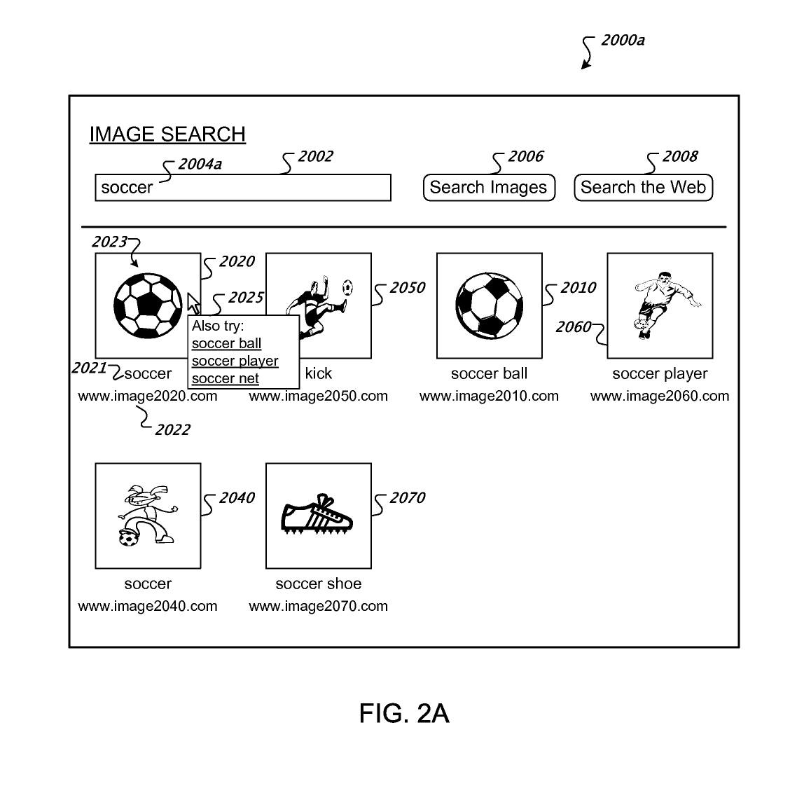

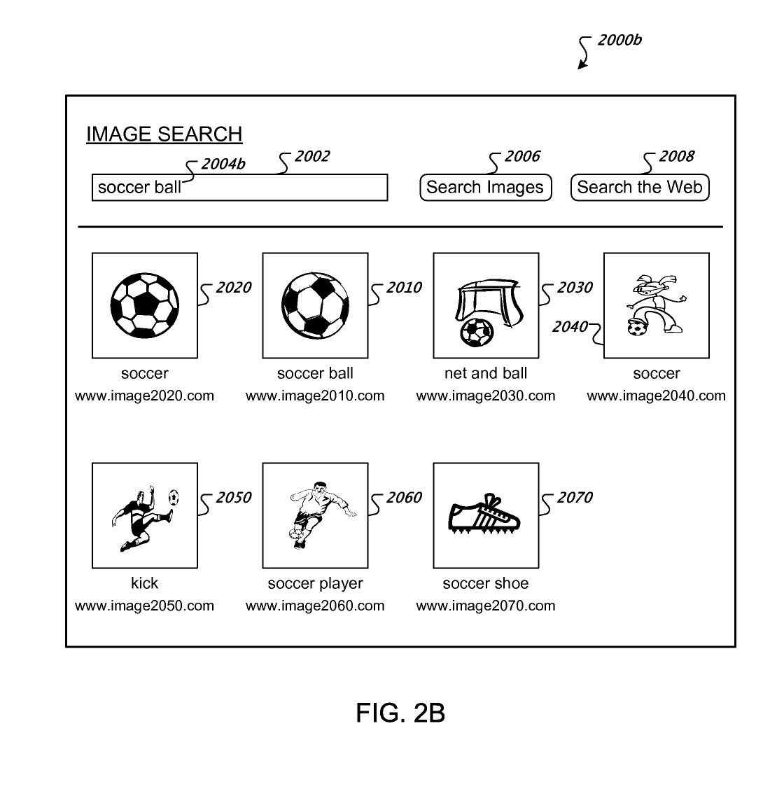

FIG. 2A illustrates an example web page 2000a of image search results including suggested alternative queries for one of the image search results. The web page 2000a includes an original query 2004a, “soccer,” entered in a search text field 2002 and a group of image search results 2020, 2050, 2010, 2060, 2040, and 2070 returned from a search engine (e.g., search engine 1030) in response to the original query 2004a. Each image search result for a particular image can include a label 2021 for the particular image from a resource, a selectable link 2022 to the resource, and a thumbnail image 2023 of the particular image. Typically, the thumbnail image 2023 can also be selected to access the resource. The web page 2000a can also include user interface elements for submitting queries for searches within an image corpus (e.g., “Search Images” button 2006) and for submitting queries for searches within a web page corpus (e.g., “Search the Web” button 2008).

The search system (e.g., search system 1014) can provide to the user one or more suggested alternative queries for the original query 2004a that are specific to a particular image search result. For example, the search engine 1030 of the search system 1014 can transmit to a client device 1004 instructions for presenting the suggested alternative queries to the user. The search system can include these instructions with the image search results corresponding to the original query 2004a. Particular techniques for generating the suggested alternative queries are described below.

For each image search result returned for the original query 2004a, the search system identifies a group of one or more suggested alternative queries relevant to that particular image search result. The search system associates each group of suggested alternative queries with the respective image search result so that a user can interact with the respective image search result to invoke a display of the associated group of suggested alternative queries. For example, the system can generate one or more client-side scripts (e.g., using JavaScript) to define the image search results as hotspots, which are regions in a hypertext document (e.g., the web page 2000a) that when selected invoke one or more actions. A client-side script can include instructions for performing the one or more actions invoked by a selection. A client-side script can be embedded within the hypertext document and executed by the web browser on the client device (e.g., client device 1004).

In some implementations, when a user interacts with an image search result defined as a hotspot, the web browser displays an overlay or dialog box that includes the suggested alternative queries specific to that image search result. The suggested alternative queries are selectable. For example, each suggested alternative query can be a hyperlink, e.g., with a Uniform Resource Locator (URL) link, to submit the respective suggested alternative query to the search engine. If a user selects one of the hyperlinks for the suggested alternative queries, the web browser submits the respective alternative query. In response, the search engine generates new image search results for the respective alternative query.

In the example of FIG. 2A, a user has interacted with the image search result 2020 including positioning a cursor over the hotspot associated with the image search result 2020 in the user interface. The user interaction invokes the web browser to display a dialog box 2025 which includes the suggested alternative image queries (i.e., “soccer ball,” “soccer player,” and “soccer net”) that the search engine associated with the image search result 2020. Each suggested alternative query displayed in the dialog box 2025 can have a corresponding embedded hyperlink for the search system. The search engine returns image search results for a selected alternative query as it would for any other query. That is, without explicitly entering a new query into the search text field 2002, a user can receive a group of image search results for a suggested alternative query by simply selecting a particular suggested alternative query displayed in the dialog box 2025. Different image search results can have different suggested alternative queries. For example, “soccer kick” might be one of the suggested alternative queries associated with the image search result 2050.

FIG. 2B illustrates an example web page 2000b of image search results returned for the suggested alternative query selected from FIG. 2A. The user selected the suggested alternative query “soccer ball” from the dialog box 2025 of FIG. 2A, which submitted the alternative query “soccer ball” to the search system. In response to the submitted alternative query, the search engine returned image search results 2020, 2010, 2030, 2040, 2050, 2060, and 2070 according to the new query 2004b “soccer ball.” In some implementations, the new query 2004b is displayed in the search text field 2002.

The suggested alternative queries allow a user to navigate through search results to narrow or broaden the subject matter of the search results without the user having to formulate new queries, for example, in the search text box 2002 and selecting the “Search Images” button 2006. Allowing users to navigate search results without entering new queries can be especially useful for users submitting queries in non-Roman based languages (e.g., Chinese, Japanese, and Korean), because entering a query in a non-Roman based language can require more keystrokes than entering the same query in a Roman based language.

In some scenarios, the image search results returned for the new query include some or all image search results returned for the original query. The image search results common to both queries can have a different rank or order in the groups of search results returned for the different queries. In some implementations, each image search result returned for the new query 2004b has one or more associated alternative queries for the new query 2004b. Consequently, the user can interact with one or more of the image search results for the new query 2004b in order to view alternative queries from which the user can select.

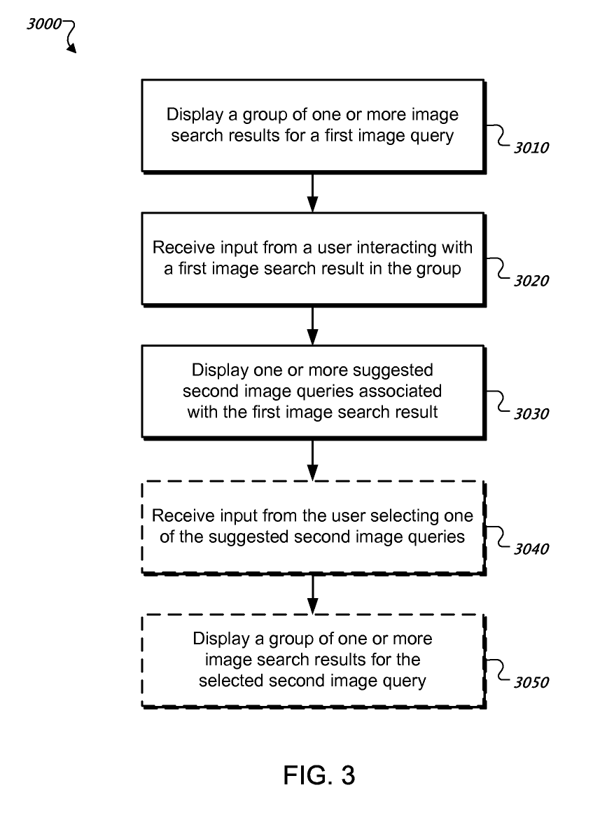

FIG. 3 shows an example process 3000 for displaying suggested second image queries. For convenience, the example process 3000 will be described with reference to FIGS. 2A-2B and a system that performs the process 3000. In some implementations, the example process 3000 is used to display suggested second queries for web page search, product search, book search, or searches in other corpuses.

For a first image query (i.e., a query for image search results), the system displays a group of one or more image search results, where each image search result refers to a respective resource and includes a link to the respective resource (step 3010). The system can display the group of one or more image search results on a display device of a client device. The first image query can be, for example, an original query submitted by a user.

The system receives input from the user interacting with a first image search result in the group of one or more image search results (step 3020). The reference to “first” is merely a label to distinguish a particular image search result from the group and does not necessarily reflect an order in the display. In the example of FIG. 2A, the user has interacted with the image search result 2020, which happens to be first in the ordered group of image search results. In some implementations, a user interacts with an image search result by moving a cursor displayed on the display device over the particular image search result (e.g., a roll-over of the particular image search result with the cursor). A web browser can receive the user input and determine whether the user positioned a cursor within a region associated with one of the image search results. The user can position the cursor within a region by manipulating an input device (e.g., a mouse or a trackball).

In response to receiving the input, the system displays one or more suggested second image queries associated with the first image search result (step 3030). For example, if the web browser determines that the cursor is positioned within a region associated with one of the image search results, the web browser can display an associated group of suggested second image queries (e.g., in a dialog box). For the first image query, which has a particular level of detail, each suggested second image query can be a broader query, a narrower or refined query, or a query of a similar level of detail. For example, if the first image query was “tennis player,” an image search result for an image of a famous tennis player can have an associated group of suggested second image queries that includes “tennis” (i.e., a broader query), the name of the famous tennis player (i.e., a narrower query), or “tennis athlete” (i.e., an alternative query of a similar level of detail.

In some implementations, each suggested second image query is identified based on selection by one or more individuals of the first image search result returned in response to prior query searches by the respective one or more individuals corresponding to the suggested second image query. In the example of FIGS. 2A-2B, “soccer ball,” “soccer player,” and “soccer net” are the suggested second image queries identified for the image search result 2020. The image search result 2020 was returned for previous searches of “soccer ball,” “soccer player,” and “soccer net.” For each of these queries, at least one individual selected the image search result 2020. The search engine can record these selections, e.g., in session logs, and interpret the selections as hints that the previous queries (i.e., “soccer ball,” “soccer player,” and “soccer net”) contain terms that are related to the image search result 2020. The identification of suggested second image queries will be discussed in more detail below.

In some implementations, the suggested second image queries are used as labels for the respective image search result. The labels can be used to identify the subject or subjects of the respective image search result. The labels can also suggest alternative image queries, which the user can enter in the search text field 2002 to obtain more image search results that are similar to the respective image search result. In other implementations, each suggested second image query is selectable to invoke a search of the respective suggested second image query.

The system optionally receives input from the user selecting one of the suggested second image queries (step 3040). For example, each suggested second image query can be a hyperlink. User selection of one of the hyperlinks can invoke the web browser to submit the respective second image query to the search engine. The search engine can then generate one or more new image search results for the selected suggested second image query.

In some implementations, the system displays a group of one or more image search results for the selected suggested second image query (step 3050). In the example of FIGS. 2A-2B, the web browser displays a group of image search results for “soccer ball” including image search result 2030. Image search result 2030 is a new image search result relative to the group of image search results for the first image query “soccer.”

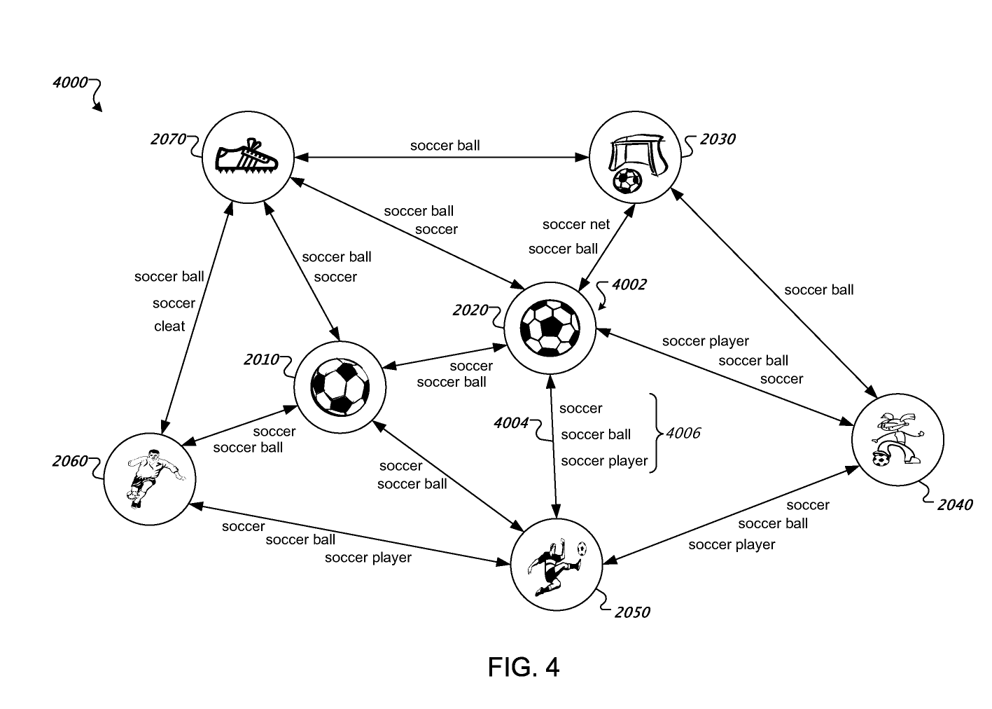

FIG. 4 illustrates an example node graph 4000 of image search result nodes and query links. The image search results and the alternative image queries of the example of FIGS. 2A-2B can be identified or generated using the example node graph 4000.

The example node graph 4000 includes multiple nodes 4002 and multiple links 4004. The nodes 4002 represent image search results (e.g., image search results 2010, 2020, 2030, 2040, 2050, 2060, and 2070). The links 4004 between the nodes 4002 represent one or more image queries 4006 that are common to the image search results represented by the respective pair of end nodes. For example, “soccer,” “soccer ball,” and “soccer player” are image queries that are common to the image search results 2020 and 2050.

For clarity, only a sampling of links and nodes are illustrated in the example node graph 4000. For example, although example node graph 4000 does not illustrate a direct link between the nodes representing the image search results 2040 and 2070, these image search results share common image queries including “soccer” and “soccer ball.” In some implementations, the nodes 4002 are connected to other nodes (not shown) by other links (not shown), where the other nodes and other links are part of a larger node graph that includes the example node graph 4000.

In some implementations, a link in the node graph represents all the image queries for which a prior search returned both image search results represented by the end nodes. In other implementations, a link represents only the image queries for which prior searches resulted in individuals selecting the image search results represented by the end nodes.

The image queries represented by a link connecting one node to another node can be used as labels or alternative image queries for each image search result represented by one of the end nodes. For example, “soccer,” “soccer ball,” and “soccer player” can be used as labels or alternative image queries for the image search results 2020 and 2050. Furthermore, “soccer net” can also be used as a label or alternative image query for the image search result 2020, because “soccer net” is represented by a link between the node representing the image search result 2020 and the node representing the image search result 2030.

In some implementations, a node graph (e.g., example node graph 4000) is displayed to a user. In one example, a web page (e.g., web page 2000a or 2000b) can include a selectable option to display the node graph including one or more links representing the present image query (e.g., the image query in the search text field 2002). In another example, the dialog box 2025 of FIG. 2A can include a selectable option to display a node graph including a node representing the image search result 2020. Alternatively, a node graph can be automatically displayed to a user, e.g., when a user hovers a cursor over an image search result. The node graph can be displayed in a new window to minimize interference with the user's search experience.

In some implementations, the similarity of image search results is determined using node graphs. For example, a degree of connectivity between nodes in a node graph is used to determine similarity. Image search results represented by nearest neighbor nodes, which are directly connected by a link, are interpreted as being very similar (e.g., semantically similar, visually similar, or both). Image search results represented by nodes that are not directly connected (e.g., connected through one or more intermediate nodes and multiple links) are interpreted as being less similar.

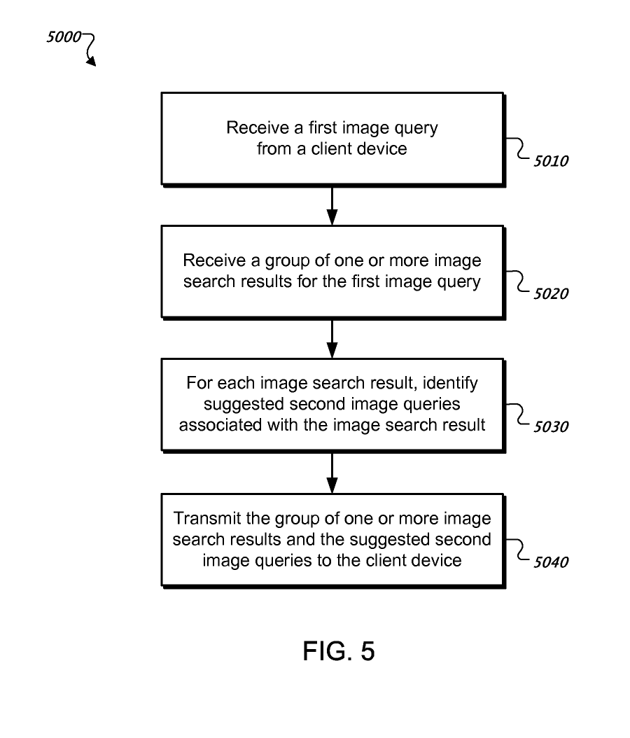

FIG. 5 shows an example process 5000 for providing suggested second image queries. For convenience, the example process 5000 will be described with reference to FIGS. 2A-2B and a system that performs the process 5000. In some implementations, the example process 5000 is used to provide suggested second queries for searches in other corpuses (e.g., web page, blogs, and news).

The system receives a first image query from a client device (step 5010). For example, a user can enter the first image query in the search text field 2002 of a web page 2000a displayed on a client device. The client device can transmit the first image query to a search system (e.g., the search system 1014 of FIG. 1). The first image query can be an original query submitted by a user.

The system receives a group of one or more image search results for the first image query, where each image search result refers to a respective resource and includes a link to the respective resource (step 5020). For example, a search engine (e.g., the search engine 1030 of FIG. 1) can process the first image query and return the group of one or more image search results to the system.

In some implementations, each image search result in the group of image search results is identified based on selection by one or more individuals of the respective image search result returned in response to prior query searches by the respective one or more individuals corresponding to the first image query. In the example of FIGS. 2A-2B, the image search results 2020, 2050, 2010, 2060, 2040, and 2070 are identified for the original query 2004a. These image search results were returned for previous searches of the original query 2004a. At least one individual selected each of these image search results. The search engine can record these selections, e.g., in session logs. Additionally, the search engine can rank the image search results for the original query 2004a based on, for example, the numbers of selections of each image search result within a specified time period.

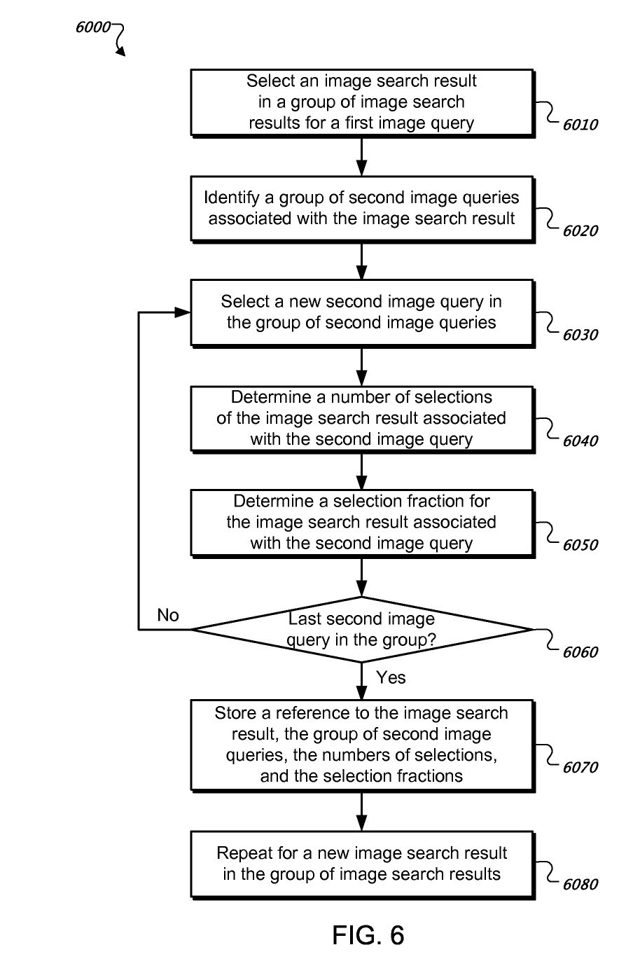

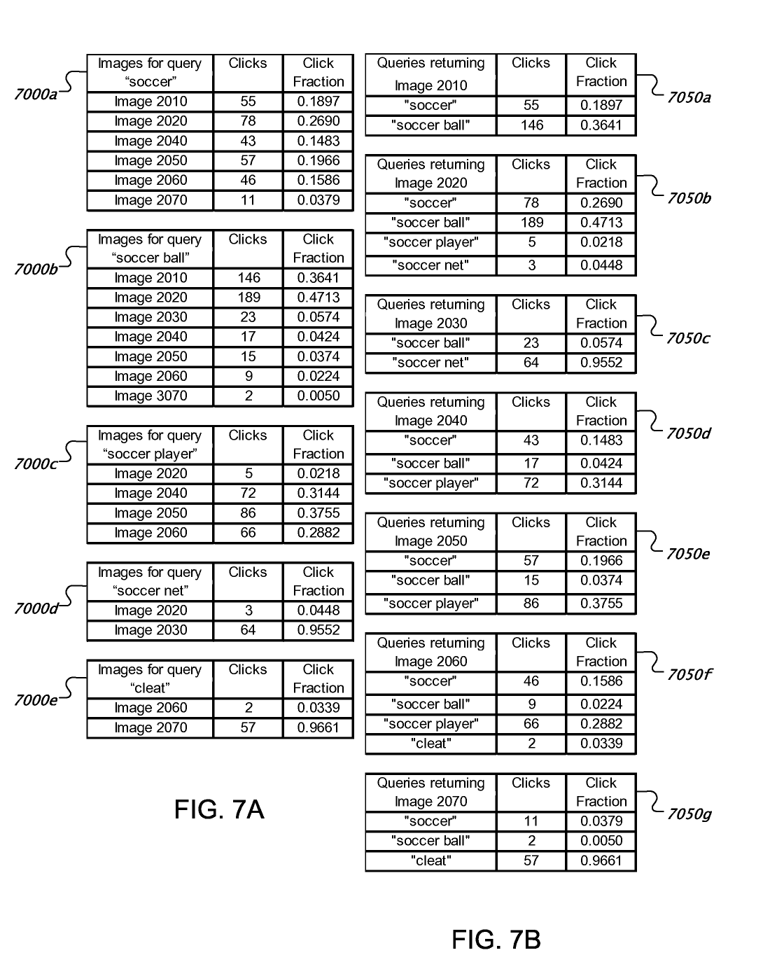

For each image search result in the group of image search results, the system identifies one or more suggested second image queries associated with the respective image search result (step 5030). In some implementations, one or more suggested second image queries are identified based on selection by one or more individuals of the respective image search result returned in response to prior query searches by the respective one or more individuals corresponding to the suggested second image queries. One example process for identifying suggested second image queries will be discussed in reference to FIGS. 6 and 7A-7B.

The system transmits the group of one or more image search results and the suggested second image queries to the client device for presentation to a user (step 5040). In some implementations, only a subgroup of the identified suggested second image queries is transmitted to the client device. For example, the system can remove identified suggested second image queries that are in a language that differs from the language of the first image query. The client device can present the image search results to the user, for example, as a web page 2000a displayed in a web browser running on the client device. In some implementations, the client device presents only a subgroup of the received suggested second image queries. For example, the dialog box 2025 may only be large enough to include a specified number of suggested second image queries.

In some implementations, each suggested second image query is selectable to invoke a search of the respective suggested second image query. The system receives input from the client device indicating that the user selected one of the suggested second image queries. The system provides the selected second image query to the search engine, and the system receives a group of one or more image search results for the selected second image query. The system transmits the group of image search results for the selected second image query to the client device for presentation to the user.

FIG. 6 shows an example process 6000 for identifying second image queries for an image search result. For convenience, the example process 6000 will be described with reference to FIGS. 2A-2B and 7A-7B and a system that performs the process 6000. FIG. 7A illustrates example tables 7000a, 7000b, 7000c, 7000d, and 7000e of image search results for individual image queries. FIG. 7B illustrates example tables 7050a, 7050b, 7050c, 7050d, 7050e, 7050f, and 7050g of image queries for individual image search results. In some implementations, the example process 6000 is used to provide suggested second queries for searches in other corpuses (e.g., products, books, and videos).

The system selects an image search result in a group of one or more image search results for a first image query (step 6010). In the example of FIGS. 7A-7B, if the first image query is “soccer,” the group of one or more image search results includes the image search results 2010, 2020, 2040, 2050, 2060, and 2070, as listed in the table 7000a. As an example for process 6000, the system selects image search result 2020 in the group of image search results for the image query “soccer.”

For the selected image search result, the system identifies a group of one or more second image queries associated with the image search result (step 6020). Continuing with the example, the system identifies “soccer ball,” “soccer player,” and “soccer net” as second image queries associated with the image search result 2020. These second image queries are listed in the table 7050b along with the first image query “soccer.” In some implementations, the system identifies the group of second image queries using a node graph (e.g., the node graph 4000 of FIG. 4). For example, the system can search for the node that represents the selected image search result and determine the image queries represented by links connecting that node with another node representing another image search result.

In some implementations, a second image query is removed from the group of second image queries if the second image query includes one or more words from a specified group of words (e.g., profanity). For example, if the second image query includes obscene or offensive words (e.g., as determined by at least one word in the second image query being included in a predetermined group of obscene or offensive words), image search results returned for the second image query can have a high likelihood of being obscene or offensive. In some implementations, a second image query is removed from the group of second image queries if the second image query is in a different language than the language of the first image query, if the second image query is identical to the first image query, or if the second image query is incorrectly spelled.

The system selects a second image query in the group of one or more second image queries associated with the selected image search result (step 6030). For example, the system selects the second image query “soccer ball” associated with the image search result 2020. The system determines a number of selections of the selected image search result associated with the selected second image query (step 6040). The number of selections can be determined as a number of instances within a time period that the image search result was selected by individuals when the image search result was returned for previous searches of the selected second image query. Continuing with the soccer example, in previous searches of the second image query “soccer ball,” the image search result 2020 was returned as one of a group of image search results. The system determines the number of instances within a time period (e.g., a specified training period) that users selected the returned image search result 2020. For example, the system can determine the number of selections (e.g., clicks) to be 189, as indicated in the table 7000b. In some implementations, the second image queries are ranked (e.g., ordered in descending order) in the group according to the number of selections. Additionally, in some implementations, only the top N second image queries (e.g., as determined by the highest number of selections) are transmitted to a client device as suggested image queries.

In some implementations, a second image query is removed from the group of second image queries if the number of selections of the selected image search result associated with the respective second image query is less than a specified threshold value (e.g., 50 selections). For example, the second image queries “soccer player” and “soccer net” would be removed from the group of second image queries if the number of selections (i.e., 5 and 3, respectively, according to the table 7050b) is less than a threshold of 50 selections. This heuristic can help prevent suggesting queries that are too obscure.

The system determines a selection fraction for the selected image search result associated with the selected second image query (step 6050). The selection fraction can be determined by computing a ratio of the number of instances within the time period the particular image search result was selected by users to a number of instances within the time period any image search result was selected by users for previous searches of the selected second image query. For the example illustrated in the table 7000b, if previous searches of the second image query “soccer ball” within a training period resulted in 189 selections (e.g., clicks) for the image search result 2020 and 212 selections for other image search results (i.e., image search results 2010, 2030, 2040, 2050, 2060, and 2070), the system can determine the selection fraction for the image search result 2020 associated with the second image query “soccer ball” by computing the ratio 189/(189+212)=0.4713. In some implementations, the second image queries are ranked (e.g., ordered in descending order) in the group according to selection fraction, and only the top N second image queries (e.g., as determined by the highest selection fractions) are transmitted to a client device as suggested image queries.

In some implementations, a second image query is removed from the group of second image queries if the selection fraction for the selected image search result associated with the respective second image query is less than a specified threshold value. For example, the second image query “soccer ball” would be removed from the group of second image queries for the image search result 2070 if the selection fraction (i.e., 0.0050, according to the table 7050g) is less than a threshold value of 0.01, which represents a selection fraction of one percent. In some implementations, the specified threshold value is 0.001.

The system can determine whether the selected second image query is the last second image query in the group (step 6060). If the selected second image query is not the last second image query in the group (i.e., the “No” branch), the system can return to step 6030 to select a new second image query and repeat steps 6040 to 6060 for the new second image query. If the selected second image query is the last second image query in the group (i.e., the “Yes” branch), the system can store in a repository (e.g., a database) a reference to the selected image search result, the group of one or more second image queries, the numbers of selections, and the selection fractions (step 6070). Continuing with the example, the system can store the data illustrated in the table 7050b in the repository. In some implementations, the reference to the selected image search result is an identifier for the selected image search result or an address (e.g., a URL) for the respective resource.

In some implementations, if a determined number of second image queries (e.g., N second image queries) are transmitted to a client device as suggested image queries, candidate second image queries in the group of second image queries are eliminated from selection for transmission if the candidate second image queries do not satisfy certain criteria. For example, the second image query with the highest number of selections can be selected as the first suggested image query. The second image query with the next highest number of selections can be the next candidate suggested image query. The candidate suggested image query can be selected as the next suggested image query if the candidate suggested image query satisfies three criteria. The criteria can include tests for lexical similarity between the candidate suggested image query and previously selected suggested image queries.

One criterion is that the candidate suggested image query is not a permutation duplicate of a previously selected suggested image query. For example, if the first suggested image query is “clown fish,” a candidate suggested image query “fish clown” fails the criterion. One criterion for queries in Roman based languages is that the candidate suggested image query should not have a string edit distance of less than x (e.g., 4 characters) from a previously selected suggested image query. For example, if the first suggested image query is “clown fish,” a candidate suggested image query “clown fishes,” with a string edit distance of 2, fails the criterion. Another criterion is that the candidate suggested image query is not a substring of a previously selected suggested image query. For example, if the first suggested image query is “clown fish,” a candidate suggested image query “fish” fails the criterion.

In some implementations, a candidate suggested image query that fails at least one criterion is eliminated from selection. In other implementations, different selection criteria are used (e.g., criteria including one or more tests for semantic similarity). The remaining N−2 suggested image queries can be selected by repeating the criteria tests for the candidate second image queries remaining in the group.

The system repeats steps 6020 to 6070 for a new image search result in the group of image search results for the first image query (step 6080). The steps 6020 to 6070 can be repeated for each remaining image search result in the group of image search results for the first image query.

In some implementations, at least one of the second image queries in the group of second image queries is used as a label for the selected image search result. For example, the second image query with the highest selection fraction can be used as a label for the selected image search result, where the label is used in the index database 1022 of the search system 1014 of FIG. 1. In another example, the label for the selected image search result is used as a label (e.g., the label 2021 of FIG. 2A) for the image search result when it is returned for a future search.

In some implementations, the system determines whether an image search result is of a particular type or genre. Example genres include both semantic genres (e.g., pornography, caricature, or science) and visual genres (e.g., photography, diagram, or clipart). In one example, an image search result can be determined as caricature if one or more identified second image queries include the term “funny.” In another example, an image search result is determined as caricature if the percentage of second image queries including the term “funny” is higher than a specified value. Identifying image search results as caricature on non-caricature can help determine which image search results should be returned for a neutral image query.

If the system determines that an image search result is of a genre (e.g., pornography) in a specified group of genres, the system can remove the image search result from the group of one or more image search results for the first image query. In some implementations, the system determines that an image search result is pornography if one or more second image queries identified for the image search result includes pornographic terms. The image search result can also be removed from the group of image search results for image queries that do not include pornographic terms. Other heuristics can be used to determine if an image search result is pornographic. For example, the system can compare the total number of selections of the image search result with a specified value, where the total number of selections is computed as the sum of the number of selections of the image search result returned for any image query within a time period. Pornographic image search results tend to have large numbers of selections. In another example, the system can determine the distribution of the numbers of selections of the respective image search result returned for any image query. Pornographic image search results tend to have relatively flat selection distributions. The system can also determine the semantic similarity of the second image queries in the group of one or more second image queries.

In some implementations, the second image queries for an image search result are used by machine learning systems. If different second image queries for an image search result have different semantic meanings, this information suggests that the image search result pertains to both semantic meanings. For example, if one second image query is “boy” and another second image query is “flower,” the information can suggest to a machine learning system that the image of the image search result includes both a boy and a flower.

The terms of a second image query for an image search result can be used as synonyms or translations of terms in other second image queries for the image search result. An image search result can be linked by search terms in two or more languages. For example, for a particular image search result, if one second image query is “flower” and another second image query is “fleur,” this information can be provided to a machine translation system as training data for translations between English and French. Some second image queries for an image search result can include both commonly used terms and domain specific terms, which can provide users with domain specific knowledge. For example, common medical terms (e.g., cradle cap) can be translated into medical terms (e.g., seborrheic dermatitis). The terms can be linked to the same image search result when one user selects the image search result based on a search for the commonly used term, while another user with domain specific knowledge selects the same image search result based on a search for the medical term.

In some implementations, second image queries for an image search result are shared with similar (e.g., semantically similar or visually similar) image search results. The similarity of image search results can be determined, for example, using hashing algorithms. For example, a byte hash computed over the image of one image search result can match the byte hash computed over the image of another image search result, indicating that the images are the same even if the two image search results differ, e.g., in the address for the respective resources. Near-duplicate images of image search results can be identified using simhash, a fingerprinting technique for search results. For example, if a first image search result has the second image query “dog,” and a similar image search result for a near-duplicate image has the second image query “beagle,” the second image query “beagle” can be shared with the first image search result. In some implementations, after second image queries are shared between similar image search results, a node graph can be generated which includes nodes representing the similar image search results and the common second image queries.

In some implementations, the system can determine labels for images which are not available on the internet or an intranet. For example, a user might wish to know what is depicted in an image (e.g., a monument shown in a digital photo taken by the user and stored on the user's client device). The user can upload the image to, e.g., a search system. The search system can determine, for example, using a byte hash or a simhash, similar images from a large image corpus (e.g., a collection or repository of images) or index. The search system can then return to the user the labels for image search results, thereby providing identifying labels and semantic concepts pertaining to the user's uploaded image. This technique for labeling images can also be used on unlabeled images available on the internet or an intranet.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, a composition of matter effecting a machine-readable propagated signal (e.g., a machine-generated electrical, optical, or electromagnetic signal), or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
providing a set of image search results for display in response to an image search query;
receiving data indicating an interaction with a particular image of the set of the image search results;
obtaining two or more sets of terms of two or more corresponding image search queries that: (i) were previously submitted by multiple users, and (ii) resulted in a selection of the particular image by the multiple users;
in response to receiving the data indicating the interaction with the particular image, providing, for selection, the two or more sets of the terms of the two or more corresponding image search queries that: (i) were previously submitted by the multiple users, and resulted in a selection of the particular image by the multiple users;
receiving an input representing a user selection of a particular set of terms, from among the two or more sets of the terms of the two or more corresponding image search queries that: (i) were previously submitted by the multiple users and (ii) resulted in a selection of the particular image by the multiple users;
generating an additional image search query that includes the particular set of the terms; and
providing an additional set of image search results for display in response to the additional image search query.

2-71. (canceled)

72. The method of claim 1, wherein the two or more sets of the terms of each of the two or more corresponding image search queries that: (i) were previously submitted by the multiple users, and resulted in a selection of the particular image by the multiple users, cause, upon selection, a search to be invoked based at least partly on the two or more sets of the terms of the two or more corresponding image search queries that: (i) were previously submitted by the multiple users, and (ii) resulted in a selection of the particular image search result by the multiple users.

73. (canceled)

74. The method of claim 1, comprising:
receiving data indicating an interaction with another particular image of the set of the image search results;
obtaining two or more sets of terms of another two or more corresponding image search queries that: (i) were previously submitted by the multiple users, and (ii) resulted in a selection of the other particular image by the multiple users; and
in response to receiving the data indicating the interaction with the other particular image, providing, for selection, the two or more sets of the terms of the other two or more corresponding image search queries that: (i) were previously submitted by the multiple users, and (ii) resulted in a selection of the other particular image by the multiple users.

75. The method of claim 1, wherein providing the set of the image search results for display in response to the image search query comprises providing a hypertext document including one or more embedded client-side scripts that, when executed by a client device, define a user-selectable hotspot display region corresponding to each image search result.

76. The method of claim 75, wherein receiving data indicating the interaction with the particular image of the set of the image search results is in response to receiving a signal indicating that a cursor is positioned over a hotspot display region corresponding to the particular image.

77. The method of claim 75, wherein providing, for selection, the two or more sets of the terms of the two or more corresponding image search queries that: (i) were previously submitted by the multiple users, and (ii) resulted in a selection of the particular image by the multiple users comprises:
providing the two or more sets of the terms of the two or more corresponding image search queries that: (i) were previously submitted by the multiple users, and (ii) resulted in a selection of the particular result by the multiple users, for display within a dialog box, wherein the two or more sets of the terms of each of the two or more corresponding image search queries that: (i) were previously submitted by the multiple users, and (ii) resulted in a selection of the particular image by the multiple users, is represented within the dialog box as a user-selectable link.

78. The method of claim 77,
wherein the input representing the user selection of the particular set of terms is received through the user-selectable link in the dialog box.

79. The method of claim 1, wherein a particular image search query is determined to be a corresponding image search query that: (i) was previously submitted by the multiple users, and (ii) resulted in a selection of the particular image search result by the multiple users, based in part on a selection fraction for the particular image search result, and wherein the selection fraction is a function of a number of selections of the particular image search result by other users when the particular image search result was provided for display to the other users in response to the particular image search query.

80. The method of claim 79, wherein the selection fraction is determined by computing a ratio of a number of instances within a specified time period in which the particular image was selected by the other users when the particular image was provided for display to the other users in response to the particular image search query to a total number of instances within the specified time period in which an image search result was provided for display to the other users in response to the particular image search query and was selected by the other users.

81. The method of claim 1, wherein providing the two or more sets of the terms of the two or more corresponding image search queries that: (i) were previously submitted by the multiple users, and (ii) resulted in a selection of the particular image search result by the multiple users for selection comprises providing the two or more sets of the terms of the two or more corresponding image search queries that: (i) were previously submitted by the multiple users, and (ii) resulted in a selection of the particular image search result by the multiple users, in an overlay over at least a portion of the provided set of the image search results.

82. A non-transitory computer readable storage device encoded with a computer program, the program comprising instructions that, if executed by one or more computers, cause the one or more computers to perform operations comprising:
providing a set of image search results for display in response to an image search query;
receiving data indicating an interaction with a particular image of the set of the image search results;
obtaining two or more sets of terms of two or more corresponding image search queries that: (i) were previously submitted by multiple users, and (ii) resulted in a selection of the particular image by the multiple users;
in response to receiving the data indicating the interaction with the particular image, providing, for selection, the two or more sets of the terms of the two or more corresponding image search queries that: (i) were previously submitted by the multiple users, and (ii) resulted in a selection of the particular image by the multiple users;
receiving an input representing a user selection of a particular set of terms, from among the two or more sets of the terms of the two or more corresponding image search queries that: (i) were previously submitted by the multiple users and (ii) resulted in a selection of the particular image by the multiple users;
generating an additional image search query that includes the particular set of the terms; and
providing an additional set of image search results for display in response to the additional image search query.

83. The device of claim 82, wherein the two or more sets of the terms of each of the two or more corresponding image search queries that: (i) were previously submitted by the multiple users, and (ii) resulted in a selection of the particular image by the multiple users, cause, upon selection, a search to be invoked based at least partly on the two or more sets of the terms of the two or more corresponding image search queries that: (i) were previously submitted by the multiple users, and (ii) resulted in a selection of the particular image search result by the multiple users.

84. (canceled)

85. The device of claim 82, wherein the operations comprise:
receiving data indicating an interaction with another particular image of the set of the image search results;
obtaining two or more sets of terms of another two or more corresponding image search queries that: (i) were previously submitted by the multiple users, and (ii) resulted in a selection of the other particular image by the multiple users; and
in response to receiving the data indicating the interaction with the other particular image, providing, for selection, the two or more sets of the terms of the other two or more corresponding image search queries that: (i) were previously submitted by the multiple users, and (ii) resulted in a selection of the other particular image by the multiple users.

86. The device of claim 82, wherein providing the set of the image search results for display in response to the image search query comprises providing a hypertext document including one or more embedded client-side scripts that, when executed by a client device, define a user-selectable hotspot display region corresponding to each image search result.

87. The device of claim 86, wherein receiving data indicating the interaction with the particular image of the set of the image search results is in response to receiving a signal indicating that a cursor is positioned over a hotspot display region corresponding to the particular image.

88. The device of claim 86, wherein providing, for selection, the two or more sets of the terms of the two or more corresponding image search queries that: (i) were previously submitted by the multiple users, and (ii) resulted in a selection of the particular image search result by the multiple users for selection comprises:
providing the two or more sets of the terms of the two or more corresponding image search queries that: (i) were previously submitted by the multiple users, and (ii) resulted in a selection of the particular image by the multiple users, for display within a dialog box, wherein the two or more sets of the terms of each of the two or more corresponding image search queries that: (i) were previously submitted by the multiple users, and (ii) resulted in a selection of the particular image by the multiple users, is represented within the dialog box as a user-selectable link.

89. The device of claim 88, wherein the
input representing the user selection of the particular set of terms is received through the user-selectable link in the dialog box.

90. The device of claim 82, wherein a particular image search query is determined to be a corresponding image search query that: (i) was previously submitted by the multiple users, and (ii) resulted in a selection of the particular image search result by the multiple users, based in part on a selection fraction for the particular image search result, and wherein the selection fraction is a function of a number of selections of the particular image search result by other users when the particular image search result was provided for display to the other users in response to the particular image search query.

91. The device of claim 90, wherein the selection fraction is determined by computing a ratio of a number of instances within a specified time period in which the particular image was selected by the other users when the particular image was provided for display to the other users in response to the particular image search query to a total number of instances within the specified time period in which an image search result was provided for display to the other users in response to the particular image search query and was selected by the other users.

92. The device of claim 82, wherein providing the two or more sets of the terms of the two or more corresponding image search queries that: (i) were previously submitted by the multiple users, and (ii) resulted in a selection of the particular image search result by the multiple users for selection comprises providing the two or more sets of the terms of the two or more corresponding image search queries that: (i) were previously submitted by the multiple users, and (ii) resulted in a selection of the particular image search result by the multiple users, in an overlay over at least a portion of the provided set of the image search results.

93. A system comprising:
one or more memory devices storing instructions; and
data processing apparatus operable to execute the instructions to perform operations comprising:
providing a set of image search results for display in response to an image search query;
receiving data indicating an interaction with a particular image of the set of the image search results;
obtaining two or more sets of terms of two or more corresponding image search queries that: (i) were previously submitted by multiple users, and (ii) resulted in a selection of the particular image by the multiple users;
in response to receiving the data indicating the interaction with the particular image, providing, for selection, the two or more sets of the terms of the two or more corresponding image search queries that: (i) were previously submitted by the multiple users, and (ii) resulted in a selection of the particular image result by the multiple users;
receiving an input representing a user selection of a particular set of terms, from among the two or more sets of the terms of the two or more corresponding image search queries that: (i) were previously submitted by the multiple users and (ii) resulted in a selection of the particular image by the multiple users;
generating an additional image search query that includes the particular set of the terms; and
providing an additional set of image search results for display in response to the additional image search query.

94. The system of claim 93, wherein the two or more sets of the terms of each of the two or more corresponding image search queries that: (i) were previously submitted by the multiple users, and (ii) resulted in a selection of the particular image by the multiple users, cause, upon selection, a search to be invoked based at least partly on the two or more sets of the terms of the two or more corresponding image search queries that: (i) were previously submitted by the multiple users, and (ii) resulted in a selection of the particular image search result by the multiple users.

95. (canceled)

96. The system of claim 93, wherein the operations comprise:
receiving data indicating an interaction with another particular image of the set of the image search results;
obtaining two or more sets of terms of another two or more corresponding image search queries that: (i) were previously submitted by the multiple users, and (ii) resulted in a selection of the other particular image by the multiple users; and
in response to receiving the data indicating the interaction with the other particular image, providing, for selection, the two or more sets of the terms of the other two or more corresponding image search queries that: (i) were previously submitted by the multiple users, and (ii) resulted in a selection of the other particular image by the multiple users.

97. The system of claim 93, wherein providing the set of the image search results for display in response to the image search query comprises providing a hypertext document including one or more embedded client-side scripts that, when executed by a client device, define a user-selectable hotspot display region corresponding to each image search result.

98. The system of claim 97, wherein receiving data indicating the interaction with the particular image of the set of the image search results is in response to receiving a signal indicating that a cursor is positioned over a hotspot display region corresponding to the particular image.

99. The system of claim 97, wherein providing, for selection, the two or more sets of the terms of the two or more corresponding image search queries that: (i) were previously submitted by the multiple users, and (ii) resulted in a selection of the particular image by the multiple users comprises:
providing the two or more sets of the terms of the two or more corresponding image search queries that: (i) were previously submitted by the multiple users, and (ii) resulted in a selection of the particular image by the multiple users, for display within a dialog box, wherein the two or more sets of the terms of each of the two or more corresponding image search queries that: (i) were previously submitted by the multiple users, and (ii) resulted in a selection of the particular image by the multiple users, is represented within the dialog box as a user-selectable link.

100. The system of claim 99, wherein the
input representing the user selection of the particular set of terms is received through the user-selectable link in the dialog box.

101. The system of claim 93, wherein a particular image search query is determined to be a corresponding image search query that: (i) was previously submitted by the multiple users, and (ii) resulted in a selection of the particular image search result by the multiple users, based in part on a selection fraction for the particular image search result, and wherein the selection fraction is a function of a number of selections of the particular image search result by other users when the particular image search result was provided for display to the other users in response to the particular image search query.

102. The system of claim 101, wherein the selection fraction is determined by computing a ratio of a number of instances within a specified time period in which the particular image was selected by the other users when the particular image was provided for display to the other users in response to the particular image search query to a total number of instances within the specified time period in which an image search result was provided for display to the other users in response to the particular image search query and was selected by the other users.

103. The system of claim 93, wherein providing the two or more sets of the terms of the two or more corresponding image search queries that: (i) were previously submitted by the multiple users, and (ii) resulted in a selection of the particular image search result by the multiple users for selection comprises providing the two or more sets of the terms of the two or more corresponding image search queries that: (i) were previously submitted by the multiple users, and (ii) resulted in a selection of the particular image search result by the multiple users, in an overlay over at least a portion of the provided set of the image search results.

104. The method of claim 1, wherein images in the provided additional set of the image search results correspond to nodes in a nodal graph connected to a particular node corresponding to the particular image, and links between the particular node and the nodes in the nodal graph are associated with the additional image search query.
